(19) United States
(12) Patent Application Publication
(10) Pub. No.: US 2026/0046972 A1
(43) Pub. Date: Feb. 12, 2026

(54) TIMING CONTROL IN WIRELESS COMMUNICATIONS

(71) Applicant: Lenovo (Singapore) Pte. Limited, Singapore (SG)

(72) Inventors: Hossein Bagheri, Urbana, IL (US); Joachim Löhr, Wiesbaden (DE); Hyejung Jung, Northbrook, IL (US); Razvan-Andrei Stoica, Essen (DE); Vijay Nangia, Woodridge, IL (US); Prateek Basu Mallick, Dreieich (DE)

(73) Assignee: Lenovo (Singapore) Pte. Limited, Singapore (SG)

(21) Appl. No.: 18/998,703

(22) PCT Filed: Jul. 24, 2023
(86) PCT No.: PCT/IB2023/057513

§ 371 Date: Jan. 27, 2025

Related U.S. Application Data
(60) Provisional application No. 63/393,217, filed on Jul. 28, 2022.
(60) Provisional application No. 63/393,219, filed on Jul. 28, 2022.

(51) Int. Cl. H04W 76/28; H04L 1/1812; H04W 52/02; H04W 72/232

(52) U.S. Cl. CPC H04W 76/28; H04L 1/1812; H04W 52/0216; H04W 72/232

(57) ABSTRACT

Various aspects of the present disclosure relate to methods, apparatuses, and systems that support timing control in wireless communications. For instance, implementations provide for determination of DRX timers such as when DRX parameters are semi-statically and/or dynamically updated. Further, implementations provide for dynamic signaling to update DRX parameters. Still further, signaling enhancements and user equipment (UE) behaviors are provided for enabling multiple simultaneous DRX configurations.

### RELATED APPLICATIONS

This application claims priority to U.S. Patent Application Ser. No. 63/393,217 filed 28 Jul. 2022 entitled “TIMING CONTROL IN WIRELESS COMMUNICATIONS,” and U.S. Patent Application Ser. No. 63/393,219 filed 28 Jul. 2022 entitled “TIMING CONTROL IN WIRELESS COMMUNICATIONS,” the disclosures of which are incorporated by reference herein in their entirety.

### TECHNICAL FIELD

The present disclosure relates to wireless communications, and more specifically to timing control in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for configuring different timers related to wireless communications, such as timers pertaining to discontinuous reception (DRX). Such systems, however, may implement static timer configurations that do not adapt to different data traffic types.

### SUMMARY

The present disclosure relates to methods, apparatuses, and systems that support timing control in wireless communications. For instance, implementations provide for determination of DRX timers such as for enabling DRX parameters to be semi-statically and/or dynamically updated. Further, implementations provide for dynamic signaling to update DRX parameters. Still further, signaling enhancements and UE behaviors are provided for enabling multiple simultaneous DRX configurations.

By utilizing the described techniques, timer configuration can be controlled and can thus reduce power consumption (e.g., by UEs) and reduce signaling overhead, such as for UEs and network entities or can reduce the scheduling delay.

Some implementations of the methods and apparatuses described herein may further include receiving a first DRX configuration including a set of DRX configuration parameters; receiving a downlink control information (DCI) including a change indication indicating at least one of an increase or a decrease to one or more of a first configuration value of a first DRX configuration parameter of the set of DRX configuration parameters, or a first timer value of a first DRX timer of a set of DRX cycles; configuring one or more of a second timer value for a second DRX timer or a second configuration value for a second DRX configuration parameter based at least in part on the change indication and at least one of the first DRX configuration parameter or the first timer value; and monitoring physical downlink control channel (PDCCH) for a media access control (MAC) entity according to a DRX functionality with at least one of: the second DRX timer configured with the second timer value; or the second configuration value for the second DRX configuration parameter.

Some implementations of the methods and apparatuses described herein may further include: where the DCI is received with a DCI format, and where the method further includes: receiving the DCI not later than a first threshold with respect to a first time reference; or receiving the DCI as an nth DCI with the DCI format received in a time window, where n<n0 and n0 includes a second threshold; further including determining the first time reference based on a boundary of a current DRX cycle of the first DRX configuration; where the set of DRX configuration parameters include one or more of: a connected mode DRX (C-DRX) cycle length; an initial value for a DRX on duration timer; an initial value for a DRX inactivity timer; or a start time instance of a DRX on duration timer; further including receiving the DCI within an active time of a current DRX cycle of the first DRX configuration; further including transmitting a hybrid automatic repeat request acknowledgement (HARQ-ACK) in response to the DCI before an end of a current DRX cycle (without applying the indicated change) such as at most ‘T’ time units prior to the end of the current cycle, where ‘T’ can be configured/indicated or pre-determined; where the first DRX configuration parameter includes a starting time instance of a DRX on duration timer associated with a next DRX cycle of the first DRX configuration, and the second DRX timer is a DRX ShortCycleTimer, where the DRX ShortCycleTimer indicates when to transition to a long DRX cycle from a short DRX cycle.

Some implementations of the methods and apparatuses described herein may further include: where the first DRX configuration parameter includes a drx-ShortCycle and the second DRX configuration parameter includes a drx-LongCycle, and where the drx-LongCycle is not a multiple of the drx-ShortCycle; further including receiving the DCI outside an active time of a current DRX cycle of the first DRX configuration; further including receiving the DCI within a minimum time gap from a time reference, and determining the time reference based on the DCI and a starting time instance of a DRX on duration timer associated with a next DRX cycle of the first DRX configuration; where the set of DRX cycles includes at least one of a current DRX cycle or a next DRX cycle of the first DRX configuration; where the method is performed at an apparatus, and: the apparatus is configured with at least two DRX groups; a first set of serving cells belongs to a primary DRX group; a second set of serving cells belongs to a secondary DRX group; the first DRX configuration belongs to the secondary DRX group, and the DCI causes a value of one or more of a DRX on duration timer or a DRX inactivity timer of the secondary DRX group to become larger than a corresponding value in the primary DRX group for a subset of DRX cycles. In an example, the number of DRX cycles of the subset of DRX cycles within a window of time is not larger than a threshold.

Some implementations of the methods and apparatuses described herein may further include: where the method is performed at an apparatus, and: the apparatus is configured with at least two DRX groups; a first set of serving cells belongs to a primary DRX group; a second set of serving cells belongs to a secondary DRX group; and the DCI indicates the increase or decrease is associated with which DRX group; where the DCI schedules a one or more of a physical downlink shared channel (PDSCH) or a physical uplink shared channel (PUSCH); further including receiving the DCI at least ‘t time units later than a different DCI of a same DCI format indicating a change to one or more DRX parameters; where the DCI includes one or more of: a DRX configuration identifier (ID) or a DRX set ID associated with the change indication; an indication of a DRX cycle ID to which the change indication applies; or a DRX group identifier; where the change indication applies; where the method is performed at a user equipment (UE), and where the method further includes receiving one or more of the first DRX configuration or the DCI from a network device.

Some implementations of the methods and apparatuses described herein may further include receiving a first DCI indicating an activity status for a first set of DRX configurations; configuring a DRX behavior based at least in part on a time instance associated with the activity status, where the time instance is determined based on at least one of a number of DRX configurations of the first set of DRX configurations, or a first DRX cycle length of one or more DRX configurations; and configuring a PDCCH behavior based at least in part on the DRX behavior and the determined time instance.

Some implementations of the methods and apparatuses described herein may further include: where the activity status includes an activation of the first set of DRX configurations, and the PDCCH behavior includes an indication to monitor PDCCH based at least in part on the first set of DRX configurations; further including monitoring PDCCH based at least in part on a combination of on-durations of the first set of DRX configurations from the time instance; where the activity status includes a deactivation of the first set of DRX configurations, and the PDCCH behavior includes an indication to not monitor PDCCH based at least in part on the first set of DRX configurations; further including determining the first set of DRX configurations based on higher layer signaling, and where the higher layer signaling includes one or more of radio resource control (RRC) configuration or MAC control element (CE) signaling; further including: receiving a DRX command MAC CE; terminating one or more current active times of a second set of DRX configurations; and entering a regular DRX cycle routine of the second set of DRX configurations.

Some implementations of the methods and apparatuses described herein may further include: where the DRX command MAC-CE includes configuration identifiers (IDs) of DRX configurations of the second set of DRX configurations; where the first DRX cycle length includes a multiple of a second DRX cycle length of the first set of DRX configurations; where: serving cells of a MAC entity are configurable by RRC into at least two DRX groups; the first set of DRX configurations is applicable a first DRX group; and a subset of the first set of DRX configurations is applicable to a second DRX group; further including transmitting one or more channel state information (CSI) reports only in an on-duration period of a subset of first set of DRX configurations; further including: receiving a second DCI outside of a DRX active time, where: the second DCI includes a wakeup signal (WUS) indication indicating whether an apparatus is to skip an on-duration of an upcoming DRX cycle of a first DRX configuration of the first set of DRX configurations; and the DCI indicates an identifier (ID) of the first DRX configuration; further including not monitoring PDCCH within a configured time gap from any DRX on-duration of the first set of DRX configurations.

Some implementations of the methods and apparatuses described herein may further include: further including receiving one or more of: a first ps-TransmitOtherPeriodicCSI configuration which is applicable to a first DRX configuration; or a second ps-TransmitOtherPeriodicCSI configuration which is applicable to a second DRX configuration; further including: receiving a ps-TransmitOtherPeriodicCSI configuration, where: the first DCI indicates applicability of ps-TransmitOtherPeriodicCSI configuration to one or more DRX configurations of the first set of DRX configurations; and the ps-TransmitOtherPeriodicCSI configuration is configured to cause the apparatus to transmit one or more periodic CSI reports when a drx-onDurationTimer of the one or more DRX configurations of the first set of DRX configurations does not start; where the one or more periodic CSI reports include one or more CSI reports other than a layer 1 reference signal received power (L1-RSRP) report; further including monitoring for the WUS within a time window of one or more of: Ps_offset1 slots prior to a beginning of an on-duration of a DRX cycle of a first DRX configuration; or Ps_offset2 slots prior to a beginning of an on-duration of a DRX cycle of a second DRX configuration; where the Ps_offset2 is determined based on one or more of: Ps_offset1; a first DRX configuration; or a second DRX configuration; where: a first set of hybrid automatic repeat request (HARQ) process identifiers (IDs) are configured for a first DRX configuration; and a second set of HARQ process IDs are configured for a second DRX configuration, where at least one HARQ process ID is different for the first DRX configuration and the second DRX configuration, and where the first DRX configuration and the second DRX configuration are from the first set of DRX configurations.

Some implementations of the methods and apparatuses described herein may further include transmitting a first DRX configuration including a set of DRX configuration parameters; transmitting a DCI including a change indication indicating at least one of an increase or a decrease to one or more of a first configuration value of a first DRX configuration parameter of the set of DRX configuration parameters, or a first timer value of a first DRX timer of a set of DRX cycles; configuring one or more of a second timer value for a second DRX timer or a second configuration value for a second DRX configuration parameter based at least in part on the change indication and at least one of the first DRX configuration parameter or the first timer value; determining a DRX active time based on one or more of the second DRX timer or the second DRX configuration parameter; and transmitting data in the DRX active time.

Some implementations of the methods and apparatuses described herein may further include: where the DCI is transmitted with a DCI format, and where the method further includes: transmitting the DCI not later than a first threshold with respect to a first time reference; or transmitting the DCI as an nth DCI with the DCI format transmitted in a time window, where n<n0 and n0 includes a second threshold; where the set of DRX configuration parameters include one or more of: a connected mode DRX (C-DRX) cycle length; an initial value for a DRX on duration timer; an initial value for a DRX inactivity timer; or a start time instance of a DRX on duration timer; further including transmitting the DCI within an active time of a current DRX cycle of the first DRX configuration; further including receiving a hybrid automatic repeat request acknowledgement (HARQ-ACK) before an end of a current DRX cycle; where the first DRX configuration parameter includes a starting time instance of a DRX on duration timer associated with a next DRX cycle of the first DRX configuration, and the second DRX timer is a DRX ShortCycleTimer, where the DRX ShortCycleTimer indicates when to transition to a long DRX cycle from a short DRX cycle.

Some implementations of the methods and apparatuses described herein may further include: where the first DRX configuration parameter includes a drx-ShortCycle and the second DRX configuration parameter includes a drx-LongCycle, and where the drx-LongCycle is not a multiple of the drx-ShortCycle; further including transmitting the DCI outside an active time of a current DRX cycle of the first DRX configuration; further including transmitting the DCI within a minimum time gap from a time reference, and where the time reference is determined based on the DCI and a starting time instance of a DRX on duration timer associated with a next DRX cycle of the first DRX configuration; where the set of DRX cycles includes at least one of a current DRX cycle or a next DRX cycle of the first DRX configuration; where: a first set of serving cells belongs to a primary DRX group; a second set of serving cells belongs to a secondary DRX group; the first DRX configuration belongs to the secondary DRX group, and the DCI causes a value of one or more of a DRX on duration timer or a DRX inactivity timer of the secondary DRX group become larger than a corresponding value in the primary DRX group for a subset of DRX cycles.

Some implementations of the methods and apparatuses described herein may further include: where an apparatus is configured with at least two DRX groups; a first set of serving cells belongs to a primary DRX group; a second set of serving cells belongs to a secondary DRX group; and the DCI indicates the increase or decrease belongs is associated with which DRX group; where the DCI schedules a one or more of a PDSCH or a PUSCH; further including transmitting the DCI at least t time units later than a different DCI of a same DCI format indicating a change to one or more DRX parameters; where the DCI includes one or more of: a DRX configuration identifier (ID) or a DRX set ID associated with the change indication; an indication of a DRX cycle ID to which the change indication applies; an indication of a DRX index to which the change indication applies; or a DRX group identifier where the change indication applies.

Some implementations of the methods and apparatuses described herein may further include transmitting DCI indicating to activate a first set of DRX configurations; determining a time instance after which the first set of DRX configurations is applicable, where the time instance is determined based on at least one of a number of DRX configurations of the first set of DRX configurations, or a DRX cycle length of one or more DRX configurations; and transmitting a PDCCH in a DRX active time determined based at least in part on on-durations of the first set of DRX configurations from the time instance.

Some implementations of the methods and apparatuses described herein may further include: transmitting a DRX command MAC CE, where the DRX command MAC-CE includes configuration identifiers (IDs) of DRX configurations of a second set of DRX configurations; transmitting, to a user equipment (UE), a second DCI outside of a DRX active time, where: the second DCI includes a WUS indication indicating whether the UE is to skip an on-duration of an upcoming DRX cycle of a first DRX configuration of the first set of DRX configurations; and the DCI indicates an identifier (ID) of the first DRX configuration; further including transmitting one or more of: a first ps-TransmitOtherPeriodicCSI configuration which is applicable to a first DRX configuration; or a second ps-TransmitOtherPeriodicCSI configuration which is applicable to a second DRX configuration; further including: transmitting a ps-TransmitOtherPeriodicCSI configuration, where: the first DCI indicates applicability of ps-TransmitOtherPeriodicCSI configuration to one or more DRX configurations of the first set of DRX configurations; and the ps-TransmitOtherPeriodicCSI configuration is configured to cause an apparatus to transmit one or more periodic CSI reports when a drx-onDurationTimer of the one or more DRX configurations of the first set of DRX configurations does not start.

### BRIEF DESCRIPTION OF THE DRAWINGS

FIG. 1 illustrates an example of a wireless communications system that supports timing control in wireless communications in accordance with aspects of the present disclosure.

FIG. 2 illustrates a DRX configuration including short DRX and long DRX operation.

FIG. 3 illustrates a scenario that supports timing control in wireless communications in accordance with aspects of the present disclosure.

FIG. 4 illustrates a scenario that supports timing control in wireless communications in accordance with aspects of the present disclosure.

FIG. 5 illustrates a scenario that supports timing control in wireless communications in accordance with aspects of the present disclosure.

FIG. 6 illustrates a scenario that supports timing control in wireless communications in accordance with aspects of the present disclosure.

FIGS. 7 and 8 illustrate examples of block diagrams of devices that support timing control in wireless communications in accordance with aspects of the present disclosure.

FIGS. 9 through 13 illustrate flowcharts of methods that support timing control in wireless communications in accordance with aspects of the present disclosure.

### DETAILED DESCRIPTION

In wireless communications systems, UE devices (e.g., extended reality (XR) devices) can be power limited, such as based on battery capacity. Accordingly, connected mode DRX (C-DRX) can be used to help UEs save power, and hence operate longer without needing to be charged. However, XR traffic characteristics, such as non-integer traffic periodicity and jitter, can result in missing an opportunity to schedule an XR video frame within an on-duration time of a DRX cycle. For instance, a video frame may arrive after an on-duration, and hence, may need to be scheduled in a next DRX cycle which in turn increases the associated latency. Such latency effects may not be desirable as XR packets may need to be delivered within a specified delay budget.

Accordingly, this disclosure provides for techniques that support timing control in wireless communications. For instance, implementations provide for determination of DRX timers such as when DRX parameters are semi-statically and/or dynamically updated. Further, implementations provide for dynamic signaling to update DRX parameters. Still further, signaling enhancements and UE behaviors are provided for enabling multiple simultaneous DRX configurations.

By utilizing the described techniques, timer configuration can be controlled and can thus reduce data scheduling latency or power consumption (e.g., by UEs) and reduce signaling overhead, such as for UEs and network entities.

Aspects of the present disclosure are described in the context of a wireless communications system. Aspects of the present disclosure are further illustrated and described with reference to device diagrams and flowcharts.

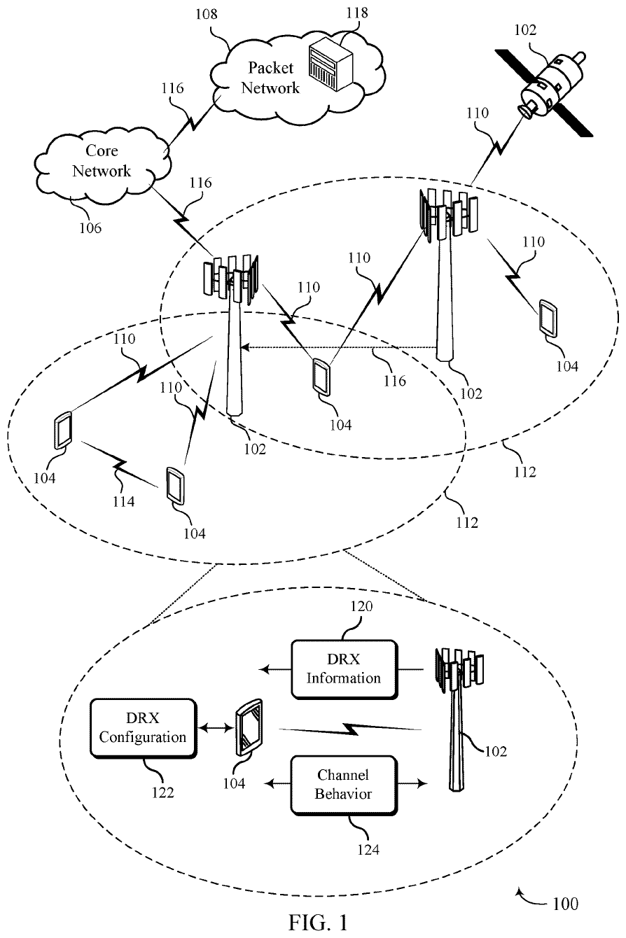

FIG. 1 illustrates an example of a wireless communications system 100 that supports timing control in wireless communications in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., RRC, service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, MAC layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU (packet data unit) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHZ), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for timing control in wireless communications, a network entity 102 generates DRX information 120 and transmits the DRX information 120 to a UE 104. The DRX information 120, for instance, includes instructions for configuring DRX behavior of the UE 104, such as DRX timers. In at least one implementation, the DRX information 120 is transmitted via DCI. The UE 104 receives the DRX information 120 and executes DRX configuration 122 based at least in part on the DRX information 120. The UE 104, for instance, performs the DRX configuration 122 to configure DRX-related behaviors of the UE 104, such as to configure DRX timers of the UE 104. Based at least in part on the DRX information 120 and the DRX configuration 122, the network entity 102 and the UE 104 participate in channel behavior 124. The channel behavior 124, for instance, indicates whether the UE 104 monitors for downlink transmission by the network entity 102 and/or whether the network entity 102 transmits downlink transmissions to the UE 104. Detailed discussions of information and behaviors that can be included as part of the DRX information 120, the DRX configuration 122, and the channel behavior 124 are presented throughout this disclosure.

XR is an umbrella term for different types of digitally enhanced realities including:
Virtual reality (VR): A rendered version of a delivered visual and audio scene. The rendering is designed to mimic the visual and audio sensory stimuli of the real world as naturally as possible to an observer or user as they move within the limits defined by the application. Virtual reality usually, but not necessarily, involves a user wearing a head mounted display (HMD) to replace the user's field of view with a simulated visual component, and wearing headphones to provide the user with accompanying audio. Some form of head and motion tracking of the user in VR is usually also implemented to allow the simulated visual and audio components to be updated in order to ensure that, from the user's perspective, visual items and sound sources remain consistent with the user's movements. Additional means to interact with the virtual reality simulation may also be provided.
Augmented reality (AR): A user is provided with additional information and/or artificially generated items or content overlaid upon their current environment. Such additional information or content may be visual and/or audible and their observation of their current environment may be direct (e.g., with no intermediate sensing, processing and/or rendering) and/or indirect, such as where their perception of their environment is relayed via sensors and may be enhanced or processed.
Mixed reality (MR): An advanced form of AR where some virtual elements are inserted into the physical scene with the intent to provide the illusion that these elements are part of the real scene.

Accordingly, XR may be used to refer to real-and-virtual combined environments and human-machine interactions generated by computer technology and wearables. XR includes representative forms such as AR, MR and VR and the areas interpolated among them. The levels of virtuality range from partially sensory inputs to fully immersive VR. A key aspect of XR is the extension of human experiences relating to the senses of existence (e.g., represented by VR) and the acquisition of cognition, e.g., represented by AR.

According to RP-213587:
Many of the XR and cloud gaming use cases are characterised by quasi-periodic traffic (with possible jitter) with high data rate in downlink (DL) (i.e., video steam) combined with the frequent uplink (UL) (i.e., pose/control update) and/or UL video stream. Both DL and UL traffic are also characterized by relatively strict packet delay budget (PDB).
The set of anticipated XR and cloud gaming services has a certain variety and characteristics of the data streams (i.e., video) may change “on-the-fly”, while the services are running over NR. Therefore, additional information on the running services from higher layers, e.g., the QoS flow association, frame-level QoS, ADU-based QoS, XR specific QoS etc, may be beneficial to facilitate informed choices of radio parameters. It is clear that XR application awareness by UE and gNB would improve the user experience, improve the NR system capacity in supporting XR services, and reduce the UE power consumption.

As discussed herein, an application data unit (ADU) or a PDU set is a smallest unit of data that can be processed independently by an application, such as processing for handling out-of-order traffic data. Further, a video frame can be an I-frame, P-frame, or can be composed of I-slices, and/or P-slices. I-frames/I-slices are more important and larger than P-frames/P-slices. An ADU can be one or more I-slices, P-slices, I-frame, P-frame, or a combination of those.

In wireless communications systems, a service-oriented design considering XR traffic characteristics (e.g., (a) variable packet arrival rate: packets coming at 30-120 frames/second with some jitter, (b) packets having variable and large packet size, (c) B/P-frames being dependent on I-frames, (d) presence of multiple traffic/data flows such as pose and video scene in uplink) can enable more efficient (e.g., in terms of satisfying XR service requirements for a greater number of UEs, or in terms of UE power saving) XR service delivery.

Latency aspects of XR traffic (e.g., on RAN side such as for air interface) can be modelled as PDB. A PDB, for instance, is a limited time budget for a packet to be transmitted over the air from a gNB to a UE. For a given packet, the delay of the packet incurred in air interface can be measured from the time that the packet arrives at a network node (e.g., gNB) to the time that it is successfully transferred to the UE. If the delay is larger than a given PDB for the packet, the packet is said to violate PDB, otherwise the packet may be considered to be successfully delivered. A value of PDB may vary for different applications and traffic types, which can be 10-20 ms depending on the application (see, e.g., TR 26.926).

According to R1-2112245: 5G arrival time of data bursts on the downlink can be quasi periodic, e.g., periodic with jitter. Some of the factors leading to jitter in burst arrival include varying server render time, encoder time, real time transport protocol (RTP) packetization time, link between server and 5G gateway etc. 3GPP agreed simulation assumptions for XR evaluation model DL traffic arrival jitter using truncated Gaussian distribution with mean: Oms, standard deviation: 2 ms, range: [−4 ms, 4 ms] (baseline), [−5 ms, 5 ms] (optional).

Applications can have a certain delay parameter on an ADU that may not be adequately translated into packet delay budget requirements. For example, if an ADU delay budget (ADB) is 10 ms, then PDB can be set to 10 ms only if all packets of the ADU arrive at the 5G system at the same time. If the packets are spread out, then ADU delay budget is measured either in terms of the arrival of the first packet of the ADU or the last packet of the ADU. In either case, a given ADB will result in different PDB requirements on different packets of the ADU. It is observed that specifying the ADB to the 5G system can be beneficial.

For delay-aware communication, delay budgets can be considered. For instance, if a scheduler (e.g., base station) and/or a UE is aware of delay budgets for a packet/ADU, the scheduler can take this knowledge into account in scheduling transmissions, e.g., by giving priority to transmissions close to their delay budget limit, and by not scheduling (e.g., UL) transmissions. Further, the UE can also take advantage of such knowledge to determine 1) if an UL transmission (e.g., physical uplink control channel (PUCCH) in response to PDSCH, UL pose, or PUSCH) corresponding to a transmission that exceeds its delay budget can be dropped (additionally, no need to wait for re-transmission of a PDSCH and no need to keep the erroneously received PDSCH in buffer for soft combining with a re-transmission that never occurs) or 2) how much of the UEs channel occupancy time in case of using unlicensed spectrum can be shared with the gNB.

A remaining delay budget 1) for a DL transmission can be indicated to the UE in a DCI (e.g., for a packet of a video frame/slice/ADU) or via a MAC-CE (e.g., for an ADU/video frame/slice) and 2) for an UL transmission can be indicated to the gNB via an UL transmission such as uplink control information (UCI), PUSCH transmission, etc.

Application awareness at a network can be implemented, e.g., ADU-related QoS aspects of XR can be conveyed to a network to optimize the communication such as ADU error rate (AER), ADB, and ADU content policy which can represents a percentage of packets/bits of an ADU to be received in order to correctly decode the ADU.

From TR 38.838.v101, in considering jitter aspects of XR, the packet arrival rate can be determined by the frame generation rate, e.g., 60 fps. Accordingly, the average packet arrival periodicity is given by the inverse of the frame rate, e.g., 16.6667 ms= 1/60 fps. The periodic arrival without jitter gives the arrival time at gNB for packet with index k (=1,2,3 . . . ) as

$$k / F * 1000 [ ms ] ,$$

where F is the given frame generation rates (per second).

Note that this periodic packet arrival may implicitly assume a fixed delay contributed from network side including fixed video encoding time, fixed network transfer delay, etc. However, in some systems, a varying frame encoding delay and network transfer time may introduce jitter in packet arrival time at a network node. The jitter, for instance, is modelled as a random variable added on top of periodic arrivals. The jitter follows truncated Gaussian distribution with following statistical parameters shown in Table 1.

TABLE 1
Statistical parameters for jitter

| | | Baseline value | Optional value |
|---|---|---|---|
| Parameter | Unit | for evaluation | for evaluation |
| Mean | ms | 0 | |
| STD | ms | 2 | |
| Truncation range | ms | [−4, 4] | [−5, 5] |

Note that the given parameter values and considered frame generation rates (e.g., 60 or 120 in this model) ensure that packet arrivals are in order, e.g., arrival time of a next packet is larger than that of the previous packet.

Thus, the periodic arrival with jitter gives the arrival time for packet with index k (=1,2,3 . . . ) as

$$offset + k / F * 1000 + J [ ms ] ,$$

where F is the given frame generation rates (per second), and J is a random variable capturing jitter. Note that actual traffic arrival timing of traffic for each UE could be shifted by the UE specific arbitrary offset.

C-DRX is a useful tool for device energy saving. C-DRX, for instance, provides two levels of PDCCH monitoring granularity via the short and long DRX configurations. C-DRX can also allow a device to monitor scheduling messages during well-defined monitoring intervals, e.g., during 10 ms on-durations once every 160 ms in long DRX. The rest of the time the device can remain in sleep mode.

DRX functionality can control a UE's PDCCH monitoring activity for a MAC entity resulting in discontinuously monitoring PDCCH. For instance, RRC signaling controls DRX operation by configuring the following parameters:
drx-onDurationTimer: the duration at the beginning of a DRX cycle (PDCCH is monitored within the on-duration);
drx-SlotOffset: the delay before starting the drx-onDurationTimer (e.g., with respect to a subframe boundary);
drx-InactivityTimer: the duration after the PDCCH occasion in which a PDCCH (received within DRX active time) indicates a new UL or DL transmission for the MAC entity;
drx-RetransmissionTimerDL (per DL HARQ process except for the broadcast process): the maximum duration
until a DL retransmission is received;
drx-RetransmissionTimerUL (per UL HARQ process): the maximum duration until a grant for UL
retransmission is received;
drx-LongCycleStartOffset: the Long DRX cycle and drx-StartOffset which defines the subframe where the Long and Short DRX cycle starts;
drx-ShortCycle (optional): the Short DRX cycle;
drx-ShortCycleTimer (optional): the duration the UE shall follow the Short DRX cycle;
drx-HARQ-RTT-TimerDL (per DL HARQ process except for the broadcast process): the minimum duration
before a DL assignment for HARQ retransmission is expected by the MAC entity;
drx-HARQ-RTT-TimerUL (per UL HARQ process): the minimum duration before a UL HARQ retransmission
grant is expected by the MAC entity;
ps-Wakeup (optional): the configuration to start associated drx-onDurationTimer (after drx-SlotOffset from the beginning of the subframe) in case DCP (Downlink Control for Power saving) is monitored but not detected;
ps-TransmitOtherPeriodicCSI (optional): the configuration to report periodic CSI that is not L1-RSRP on
PUCCH during the time duration indicated by drx-onDurationTimer in case DCP is configured but associated
drx-onDurationTimer is not started;
ps-TransmitPeriodicL1-RSRP (optional): the configuration to transmit periodic CSI that is L1-RSRP on PUCCH during the time duration indicated by drx-onDurationTimer in case DCP is configured but associated drxonDurationTimer is not started;
uplinkHARQ-Mode (optional): the configuration to set the HARQ mode per UL HARQ process.

Serving Cells of a MAC entity may be configured by RRC in two DRX groups with separate DRX parameters. When RRC does not configure a secondary DRX group, there may be only one DRX group and all serving cells belong to that one DRX group. When two DRX groups are configured, each serving cell can be uniquely assigned to either of the two groups. The DRX parameters that are separately configured for each DRX group are: drx-onDurationTimer, drxInactivityTimer. The DRX parameters that are common to the DRX groups are: drx-SlotOffset, drxRetransmissionTimerDL, drx-RetransmissionTimerUL, drx-LongCycleStartOffset, drx-ShortCycle (optional), drxShortCycleTimer (optional), drx-HARQ-RTT-TimerDL, drx-HARQ-RTT-TimerUL, and uplinkHARQ-Mode (optional).

According to TS38.321: if the Short DRX cycle is used for a DRX group, and [(system frame number (SFN)×10)+subframe number] modulo (drx-ShortCycle)=(drx-StartOffset) modulo (drx-ShortCycle); the UE starts drx-onDurationTimer for this DRX group after drx-SlotOffset from the beginning of the subframe, wherein SFN represents System Frame Number, and a frame is 10 ms long, and subframe can be 1 ms long.

According to TS38.321: if the Long DRX cycle is used for a DRX group, and [(SFN×10)+subframe number] modulo (drx-LongCycle)=drx-StartOffset:
if DCP (DCI with cyclic redundancy check (CRC) scrambled by packet switched (PS)-radio network temporary identifier (RNTI)) monitoring is configured for the active DL bandwidth part (BWP) as specified in TS 38.213 [6], clause 10.3:
   if DCP indication associated with the current DRX cycle received from lower layer indicated to start drxonDurationTimer, as specified in TS 38.213; or
   if all DCP occasion(s) in time domain, as specified in TS 38.213, associated with the current DRX
   cycle occurred in Active Time considering grants/assignments/DRX
   Command MAC CE/Long DRX
   Command MAC CE received and Scheduling Request sent until 4 ms prior to start of the last DCP
   occasion, or during a measurement gap, or when the MAC entity monitors for a PDCCH transmission on the search space indicated by recoverySearchSpaceld of the SpCell identified by the C-RNTI while the ra-ResponseWindow is running (as specified in clause 5.1.4); or
   if ps-Wakeup is configured with value true and DCP indication associated with the current DRX cycle has not been received from lower layers:
      start drx-onDurationTimer after drx-SlotOffset from the beginning of the subframe.
else:
   start drx-onDurationTimer for this DRX group after drx-SlotOffset from the beginning of the subframe.

For conditions for using short DRX or long DRX, according to TS 38.321:
if drx-InactivityTimer for a DRX group expires:
   if the Short DRX cycle is configured:
      start or restart drx-ShortCycleTimer for this DRX group in the first symbol after the expiry of drxInactivityTimer;
      use the Short DRX cycle for this DRX group.
   else:
      use the Long DRX cycle for this DRX group.

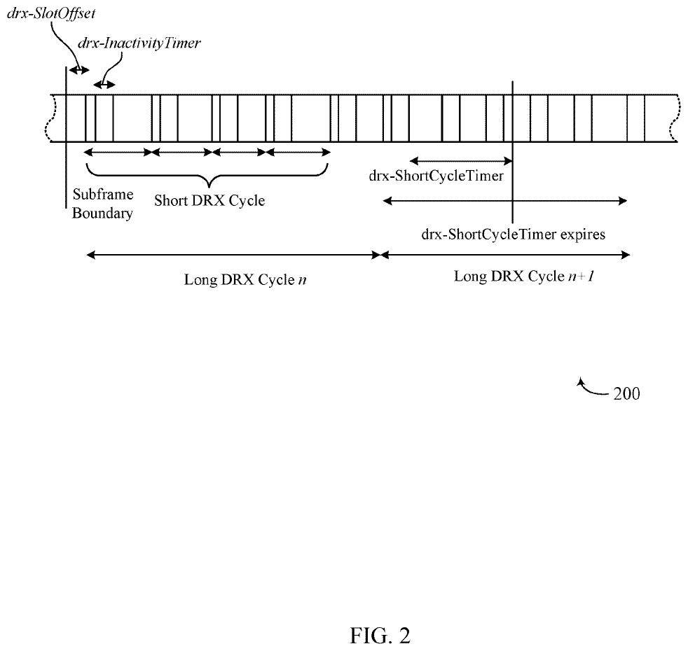

FIG. 2 illustrates a DRX configuration 200 including short DRX and long DRX operation. For instance, the DRX configuration 200, a UE monitors PDCCH according to Short DRX and switches to Long DRX when drx-ShortCycleTimer expires, e.g., no data is scheduled within two consecutive Short DRX cycles.

A WUS (e.g., a DCI with DCI format 2-6) can be transmitted to a device such as a UE ahead of an ON-duration if the network intends to schedule the device in that ON-duration. Thus, if the device does not detect the WUS during the monitoring occasion, it can skip the upcoming PDCCH monitoring (ON-duration).

Accordingly, solutions are provided in this disclosure to determine updated sets of DRX parameters for a set of DRX cycles based on a DCI indication of a DRX parameter that is different than the set of DRX parameters, and to enhance signaling (e.g., RRC, MAC-CE, DCI, etc.) to enable multiple simultaneous DRX configurations.

According to one or more implementations, if a DCI within a DRX active time indicates an update to one or more of C-DRX cycle, OnDurationTimer, or InactivityTimer for a current DRX cycle, the following implementations, details, and examples can apply.

In at least some implementations, a UE:

Receives a DCI within DRX active time of a DRX cycle;
The DCI indicates an update to a set of DRX cycles;
   The set of DRX cycles includes one from the current DRX cycle, and one or more of future DRX cycles;
   The update includes one or more of;
      extending or shrinking DRX cycles of the set of DRX cycles by a first set of offsets with respect to a set of boundaries of the DRX cycles of the set of DRX cycles;
         the first set of offsets can include a 1^{st} offset;
         the 1^{st} offset is selected from a determined set of possible offsets ‘OC’;
      extending or shrinking DRX active times of DRX cycles of the set of DRX cycles by a 2^{nd} set of offsets;
         the second set of offsets can include a 2^{nd} offset;
         the 2^{nd} offset is with respect to a current boundary (end) of the DRX active time
         the 2^{nd} offset is selected from a determined set of possible offsets ‘OA’;
         ‘OA’ is determined based on one or more of;
         The time unit (e.g., ms vs. sub-millisecond) of a DRX timer (e.g., drx-onDuration Timer)

Further, the DCI:
Can be of format 0_1 or 1_1 (UL or DL DCI);
May not be received:
   later than a threshold from the end of the DRX cycle.
   more than a number of times (e.g., more than once) within the DRX cycle;
      the number of times can be a UE capability which can be reported to the network by the UE.
   earlier than ‘W’ time units (e.g., ms or a fraction of ms or slots) after another DCI of the same DCI format indicating a change to DRX parameters.
Indicates a DRX configuration ID of the DRX configuration to which the DCI is applicable;
   alternatively or additionally, the 1^{st} or the 2^{nd} offset is applicable to the DRX configuration which has closest cycle length to a video frame inter-arrival time (1/frames per second (FPS) of XR traffic)
Indicates an offset with respect to a current boundary of the current DRX cycle:
   The offset is in a fixed time unit (e.g., ms) or in a time unit associated with a reference sub-carrier spacing (SCS);
      The reference SCS can be:
         the smallest SCS of the DRX group;
         the SCS of the received PDCCH;
      the offset can be a non-negative value
   the next DRX cycle starts after the current DRX cycle
Indicates an offset with respect to current boundary (end) of the DRX active time, the offset is applicable to:
   the on-duration if the on-duration timer is running.
      if the drx-onDurationTimer is in subMilliSeconds, the offset is chosen from a first set of values, e.g., a set of multiples of 1/32 ms
      if the drx-onDurationTimer is in milliseconds, the offset is chosen from a second set of values, e.g., a set of multiples of 1 ms
   the inactivity time if the inactivity timer is running
      the offset is in multiples of ms
Set of DRX cycles:
   the set of DRX cycles with extended or shrunk DRX cycles can be different than the set of DRX cycles with extended or shrunk DRX active times.
      In at least one example, the set of DRX cycles with extended or shrunk DRX cycles can include the current and the next DRX cycles, and the set of DRX cycles with extended or shrunk active time can include the current DRX cycle.

In at least some implementations, when two DRX groups are configured, the DRX parameters for each DRX cycle is the same for the two DRX groups except drx-onDurationTimer, and drxInactivityTimer. For instance, if a DRX cycle is prolonged in a first DRX group (e.g., via DCI indicating a change to the DRX cycle), the corresponding DRX cycle is also similarly prolonged in a second DRX group.

There could be restrictions on the timer (e.g., on-duration timer or inactivity timer) values for the case of having more than one DRX group, for instance:

drx-InactivityTimer
Value in multiple integers of 1 ms. ms0 corresponds to 0, ms1 corresponds
to 1 ms, ms2 corresponds to 2 ms, and so on, as specified in TS 38.321
[3]. The network configures a drx-InactivityTimer value for the second
DRX group that is smaller than the drx-InactivityTimer configured for the
default DRX group in IE DRX-Config.
drx-onDurationTimer
Value in multiples of 1/32 ms (subMilliSeconds) or in ms (milliSecond).
For the latter, value ms1 corresponds to 1 ms, value ms2 corresponds to 2
ms, and so on, as specified in TS 38.321 [3]. The network configures a
drx-onDurationTimer value for the second DRX group that is smaller than
the drx-onDurationTimer configured for the default DRX group in IE
DRX-Config.

In at least some implementations, after updating DRX parameters (e.g., dynamically via a DCI indicating a change to a DRX cycle or semi-statically, e.g., via configuring a periodic pattern for a set of consecutive DRX cycles), such as on-duration or inactivity timer:
the value of on-duration timer for the secondary DRX group may be larger than the on-duration timer value of the first DRX group, for instance, if the XR traffic is carried on a serving cell belonging to the secondary DRX group or
the new (updated) value of inactivity timer for the primary DRX group may be smaller than the inactivity timer value of the secondary DRX group, for instance, if the XR traffic is carried on a serving cell belonging to the primary DRX group
Note: the embodiment may be possible in a subset of DRX cycles (e.g., once every three DRX cycles, etc.)

In at least some implementations, if the Short DRX cycle is configured, upon expiry of drx-InactivityTimer for the DRX group, drx-ShortCycleTimer for this DRX group in the first symbol after the expiry of drxInactivityTimer is started/restarted. The configured ShortCycleTimer value is in multiples of drx-ShortCycle (which is configured in unit of ms). For instance, with the update of a DRX cycle (e.g., via DCI or semi-statically):
Alt1: In at least one implementation, the ShortCycleTimer value is effectively in ‘ms’ unit. For instance, if the configured drx-ShortCycle is 8 ms, and the configured ShortCycleTimer value is 2; then the ShortCycleTimer runs for 16 ms.
Alt2: In at least one implementation, the ShortCycleTimer value is effectively in number of actual DRX cycles unit. For instance, if the configured drx-ShortCycle is 8 ms, and the configured ShortCycleTimer value is 2; and if the first DRX cycle is 8 ms, and the second DRX cycle is 9 ms (updated/prolonged for 1 ms based on a DCI signaling or according to a DRX cycle pattern configured semi-statically), then the ShortCycleTimer runs for 17 ms (8 ms+9 ms).
In at least one implementation, a higher layer message (e.g., RRC or MAC-CE) chooses between Alt1 and Alt2 above.

In at least some implementations, if the Short DRX cycle is configured, the value of drx-LongCycle:
In at least one implementation: shall be a multiple of the configured drx-ShortCycle value. For instance, the configured drx-ShortCycle is 8 ms, and the configured drx-LongCycle is 80 ms.
In at least one implementation: shall be sum of multiple short DRX cycle lengths. For instance, the configured drx-ShortCycle is 8 ms, and the configured drx-LongCycle is 80 ms, but the actual drx-LongCycle is 81 ms due to having one of the short DRX cycles being prolonged to 9 ms instead of 8 ms (based on a DCI or a semiOstatic DRX cycle pattern).
The UE provides HARQ-ACK in response to the DCI

In at least some implementations, for DCI Signaling outside DRX active time, a similar indication as of WUS can be used outside DRX active time to update the next DRX cycle. For instance, DRX cycle starting time can be adjusted by a configured offset from where the WUS-like signal is detected or is indicated by the WUS/WUS-like signal payload content.

In at least some implementations, if a UE reports for an active DL BWP a MinTimeGap value that is X slots prior to the beginning of a slot where the UE would start the drx-onDurationTimer, the UE is not required to monitor PDCCH for detection of DCI format 2_6 during X slots, where X corresponds to the MinTimeGap value of the SCS of the active DL BWP. For instance, a DCI (indicating an early start of a DRX cycle at time t1) received in time t2, can be expected to be received if t2−t1>=MinTimeGap; otherwise the UE can ignore the DCI command.

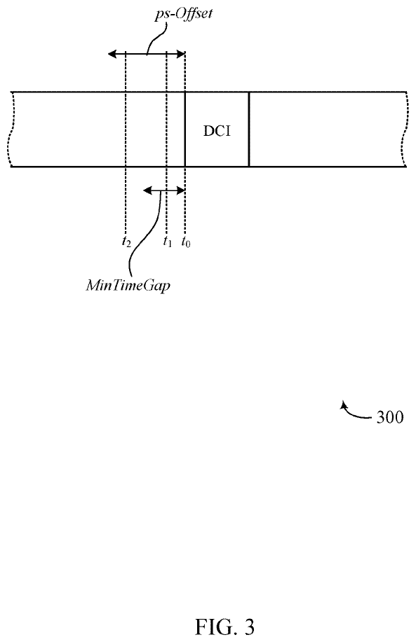

FIG. 3 illustrates a scenario 300 that supports timing control in wireless communications in accordance with aspects of the present disclosure. The scenario 300, for instance, illustrates that a DCI which indicates to shift/move an on-duration start time of a DRX cycle from t₀ to t₁ is to be received not later than MinTimeGap prior to t₁.

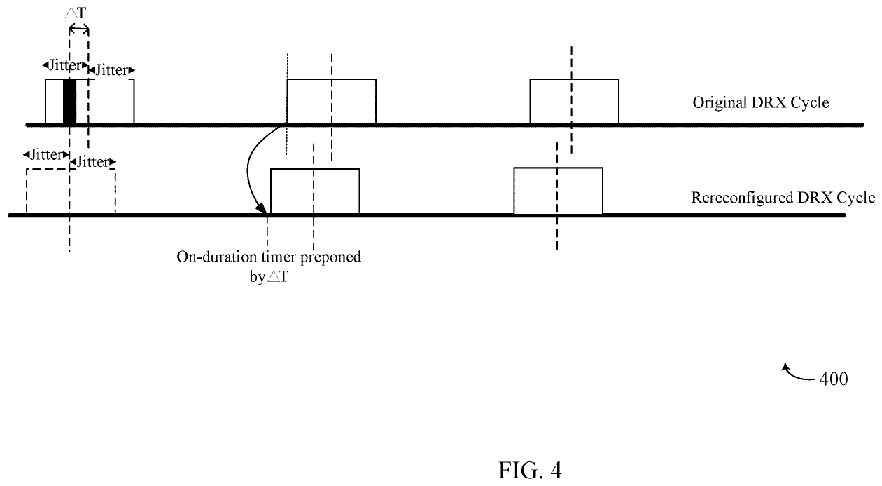

FIG. 4 illustrates a scenario 400 that supports timing control in wireless communications in accordance with aspects of the present disclosure. In at least some implementations, a transmitting node detects a shift in actual arrival of XR data at layer 2 (L2). For instance, the data arrives approximately at a mean traffic arrival time within a jitter value boundary (e.g., within a 4 ms window on each side of the mean value). In the scenario 400, an actual arrival of XR data packet is earlier by time ΔT with respect to the mean value. The transmitter uses the information of shifted time (ΔT) to modify the DRX configuration from the next start of the on-duration timer. This shift can be done implicitly by the transmitter, and optionally or additionally, controlled by a serving network. The network, for instance, may allow and/or disallow such implicit DRX configuration shift. The receiver of the XR data can be informed by the shift using explicit signalling (e.g., using RRC, MAC, or PHY) to notify about the reconfigured DRX offset. In an example, if the UE detects a DCI with a DCI format, the UE starts an on-duration timer of a DRX cycle earlier than the time determined from the DRX configuration; if the UE does not detect a DCI with the DCI format, the UE starts the on-duration timer of the DRX cycle according to the time determined from the DRX configuration. In an example, a DRX configuration comprises two (or more) configured drx-onDurationTimer values (e.g., drx-onDurationTimer-1, and drx-on DurationTimer-2), and if the UE detects a DCI with the DCI format, the UE uses drx-on DurationTimer-1 for the DRX cycle, and if the UE does not detect a DCI with the DCI format, the UE uses drx-onDurationTimer-2 for the DRX cycle. Similarly, a DRX configuration comprises two (or more) configured drx-SlotOffset values (e.g., drx-SlotOffset-1, and drx-SlotOffset-2), and if the UE detects a DCI with the DCI format, the UE uses drx-SlotOffset-1 for the DRX cycle, and if the UE does not detect a DCI with the DCI format, the UE uses drx-SlotOffset-2 for the DRX cycle. Similarly, a DRX configuration comprises two (or more) configured drx-LongCycleStartOffset values (e.g., drx-LongCycleStartOffset-1, and drx-LongCycleStartOffset-2), and if the UE detects a DCI with the DCI format, the UE uses drx-LongCycleStartOffset-1 for the DRX cycle, and if the UE does not detect a DCI with the DCI format, the UE uses drx-LongCycleStartOffset-2 for the DRX cycle.

In at least some implementations, semi-static DRX cycle updates are provided. For instance, knowing an expected XR traffic arrival rate, a fixed time shift can be applied for the start of drx-onDurationTimer for a DRX cycle every ‘N’ DRX cycles, wherein ‘N’ can be determined e.g., based on the XR FPS (frame-per-second) or RRC signaling.

Further, implementations can provide multiple simultaneous DRX configurations, which can assist in scheduling transmissions corresponding to different traffic in a timely manner, e.g., by providing on-durations in several occasions according to expected traffic arrivals. For instance, video traffic can be a pseudo periodic traffic expected with inter-arrival times of about 1/fps (e.g., 16.67 ms corresponding to 60 ms); and a voice traffic may be a periodic traffic with 10 or 20 ms periodicity.

In at least some implementations, a UE can monitor the PDCCH while the drx-onDurationTimer (or drx-InactivityTimer) is running in any of the DRX configurations, e.g., the overall active time is a logical ‘OR’ of the active times given by each DRX configuration.

Further, signaling can be provided for activation of DRX configurations by PDCCH such as for “DRX activation PDCCH”. PDCCH can be used to dynamically adapt DRX configuration.

According to one or more implementations, a DCI format is provided for activation of a DRX configuration. DRX configurations, for instance, are preconfigured by higher layer signalling and PDCCH is used to activate different DRX configurations. DRXconfigID (or a list of DRXconfig IDs) is in the DCI format.

According to one or more implementations, DRX activation can be combined with an initial DL and/or UL transmission. For instance, an existing DCI format can be reused (e.g., DCI scheduling DL transmissions) and unused and/or reserved fields can be used to indicate DRX activation and/or reactivation in conjunction with a DL allocation. When using a new RNTI, some existing fields can be repurposed to signal activation and/or deactivation of a DRX configuration.

According to one or more implementations, a DCI indicates a list of activation and/or deactivation states in which each state can be mapped to a single or multiple DRX configurations to be activated or deactivated when the corresponding DCI is received, e.g., RRC configuration parameter DRX (De) activationStateList.
Alternatively or additionally, the DCI can indicate a bitmap, wherein each bit of the bitmap is associated with a RRC configured DRX configuration, and a bit of the bitmap with value ‘1’ indicates the corresponding DRX configuration is active and the bit of the bitmap with value ‘0’ indicates the corresponding DRX configuration is not active.
If a UE is provided more than one DRX configurations, a value of the HARQ process number field in a DCI format indicates an activation for a corresponding DRX configuration with a same value as provided by DRX configuration index (e.g., provided by a RRC parameter DRXConfigIndex)
If a UE is provided more than one DRX configurations
   if the UE is provided a RRC parameter (e.g., DRXConfigDeactivationStateList), a
   value of the HARQ process number field in a DCI format indicates a corresponding entry for releasing/de-activating one or more DRX configurations
   if the UE is not provided DRXConfigDeactivationStateList, a value of the HARQ process number field in a DCI format indicates a release/deactivation of a corresponding DRX configuration with a same value as provided by DRXConfigIndex

According to one or more implementations, DCI can indicate to activate another DRX configuration (multiple active DRX configurations) or replace an existing DRX configuration (reactivation) with an updated DRX parameter (e.g., value of on-duration timer).

According to one or more implementations, such as for enhancing reliability of PDCCH based activation/adaptation and to address a false alarm problem of the DCI detection (falsely/mistakenly detecting that a DCI with a DCI format indicating an update to a DRX cycle), a “virtual CRC” concept can be used:
Certain DCI fields can have pre-determined values, and the UE upon detecting the DCI checks whether those fields have the pre-determined values. In response to determining that at least one of those fields does not the corresponding pre-determined value, the UE discards the DCI.
ACK/NACK can be provided by the UE to the network for the PDCCH carrying the DCI.
DRXonduration offset is determined based on the PDCCH DRX activation command (e.g., based on the arrival/detection time of the PDCCH carrying a DCI indicating a DRX configuration is activated or based on the DCI content of the PDCCH).

According to one or more implementations, for timing of DRX configuration activation regarding switching and/or updating DRX configuration(s), UE behaviour can be specified. For instance, UE behaviour for transitioning between different DRX configurations can be as follows:
The UE uses at least:
   ‘n1’ time units (e.g., slots) for switching a 1^{st} DRX configuration to a 2^{nd} DRX configuration:
      At least when the DRX cycle length is different between the two DRX configurations;
   ‘n2’ time units (e.g., slots) for adding ‘m’ DRX configurations, wherein ‘m’<=T1 (a threshold number);
   ‘n3’ time units (e.g., slots) for adding ‘m’ DRX configurations, wherein ‘m’>T1, and wherein ‘n3>n2’;
   ‘n4’ time units (e.g., slots) for removing ‘k’ DRX configurations, wherein ‘k’<=T2 (a threshold number);
   ‘n5’ time units (e.g., slots) for removing ‘k’ DRX configurations, wherein ‘k’>T2 (a threshold number);

According to one or more implementations, DRX cycles (short and/or long) can be multiples of each-other:
drx-ShortCycle in a 1^{st} DRX configuration and a 2^{nd} DRX configuration (DRXconfig) are multiple of each other (e.g., same DRX short cycle among the two DRX configurations, and just the on-duration timer or inactivity timer could be different among the two DRX configurations)
long DRX cycles are the same/multiple of the other

According to one or more implementations, for multiple DRX groups:
RRC configures multiple simultaneous DRX configs per DRX group.
A UE reports in a UE capability report the maximum number of simultaneous DRX configs per DRX group.
A UE reports in a UE capability report the maximum number of simultaneous DRX configs over both DRX groups (if the UE is configured with two DRX groups e.g., as defined in TS 38.321).
A first subset of a set of simultaneous DRX configs are applicable to a first DRX group and a second subset of the set of simultaneous DRX configs are applicable to a second DRX group.
A serving cell and all simultaneous DRX configurations of the serving cell belong only to a single DRX group
Alternatively, a pair of serving cell and DRX configuration can be configured to be associated with a DRX group: for instance (serving cell c1, DRX configuration drx1) belongs to DRX group 1, and (serving cell c1, DRX configuration drx2) belongs to DRX group 2

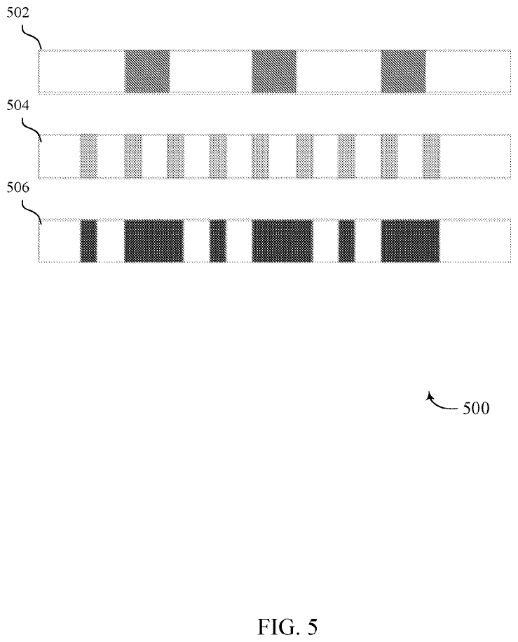

FIG. 5 illustrates an example scenario 500 that supports timing control in wireless communications in accordance with aspects of the present disclosure. The scenario 500 includes a first DRX configuration 502 including on-durations, a second DRX configuration 504 including on durations, and a superposition 506 of the on-durations of the first DRX configuration 502 and the second DRX configuration 504.

According to one or more implementations, the UE has more than one active/enabled DRX configuration (e.g., for at least a serving cell); within active time of the resulting DRX configuration (including all active times of all active/enabled DRX configurations), the UE receives a first scheduling DCI scheduling a new data transmission. The UE determines which drx inactivity timer is to be (re) started. The following are possible:
If the first scheduling DCI is received within an on-duration of a first DRX configuration only, the UE (re) starts the IAT (in-activity timer) corresponding to the first DRX configuration
If the first scheduling DCI is received within a period that belongs to both on-duration of the first DRX configuration and on-duration of the second DRX configuration, the UE (re) starts IATs corresponding to both first and second DRX configurations
Alternatively, the UE (re) starts IAT corresponding to the DRX configuration (among the first and second DRX configurations) with corresponding on-duration ends first/last.
For simultaneous DRX configurations, only one IAT (IAT-sim) is defined/configured
the configured IAT (IAT-sim) could be different than the configured IAT when there is one DRX configuration active/applicable/enabled (at least for a serving cell or for a DRX group)
IAT-sim is determined based on IAT-1 and IAT-2, wherein IAT-1 is the configured IAT value corresponding to the first DRX configuration, and IAT-2 is the configured IAT value corresponding to the second DRX configuration
For instance, IAT-sim is the larger/smaller of IAT-1 and IAT-2

According to one or more implementations, when transitioning to a long DRX for a DRX configuration and if there is no data activity during a period defined by drx-ShortCycleTimer×(times/multiplied by) drx-ShortCycle, the UE enters a long DRX cycle. The UE, for instance, enters Long DRX Cycle upon the drx-ShortCycleTimer number of short cycles. In at least some implementations a UE can be in a long DRX cycle for a first DRX configuration and be in a short DRX cycle for the second DRX configuration.

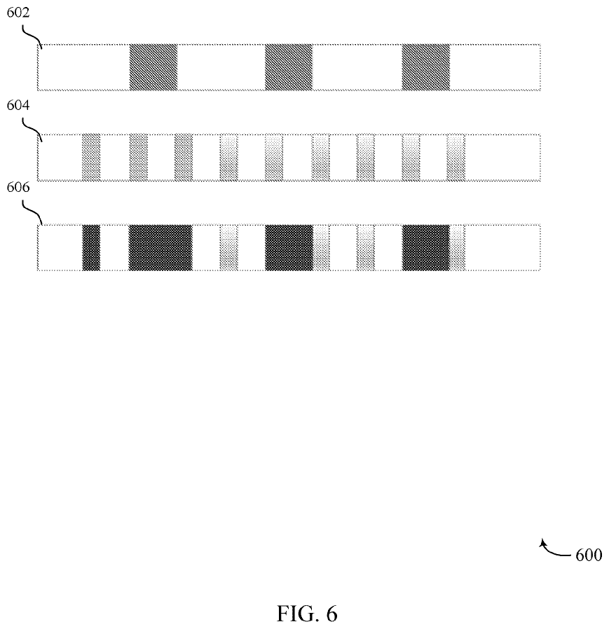

FIG. 6 illustrates an example scenario 600 that supports timing control in wireless communications in accordance with aspects of the present disclosure. The scenario 600 includes a first DRX configuration 602 including short DRX cycles. After three short DRX cycles in the first DRX configuration 602 a UE switches to a second DRX configuration 604 including long DRX cycles. An aggregate/superposition of the first DRX configuration 602 and the second DRX configuration 604 is illustrated at 606.

According to one or more implementations, for multiple simultaneous DRX configurations:
A ‘DRX Command MAC CE’ can cause a UE to terminate the current active time of the associated DRX configuration and enter regular DRX cycle routine of the associated DRX configuration.
   DRX command MAC-CE includes the DRX config ID
A ‘DRX Command MAC CE’ can cause a UE to terminate current active time(s) of an aggregate DRX configuration and enter a regular DRX cycle routine of the aggregate DRX configuration.
   A reference DRX configuration can be determined (e.g., the DRX configuration with a largest DRX cycle) and the regular DRX cycle routine can be the DRX cycle routine of the reference DRX configuration.
A ‘DRX Command MAC CE’ can cause a UE to terminate the current active time(s) of a subset of DRX configurations and enter a regular DRX cycle routine of a subset of DRX configurations.
   DRX command MAC-CE can include the ID of the subset of the DRX configurations
      Alternatively or additionally, a DRX command MAC-CE includes DRXConfigDeactivationStateList

According to one or more implementations, for WUS (or a WUS-like signaling) corresponding to multiple simultaneous DRX configurations:
1. A WUS indicates the ID of a DRX configuration for wakeup or skip
2. Ps_offset and MinTimeGap can be configured, defined, or applied per DRX configuration
   a. Alternatively, applied per reference DRX configuration, when the gap and/or offset is applicable to all DRX configurations;
   b. Alternatively or additionally, a UE monitors for the WUS within Ps_offset of a DRX cycle of a first DRX configuration from a set of DRX configurations, such as where the DRX cycle occurs earlier than DRX cycles of other DRX configurations (e.g., with respect to a reference time)
   c. MinTimeGap can be the same among DRX configurations. A UE, for instance, does not monitor PDCCH earlier than MinTimeGap from any DRX on duration, or different MinTimeGap parameters can be defined for different DRX configurations/different frequency ranges (e.g., FR1 and FR2)/different DRX groups.

For a csi-Mask (e.g., configured via RRC signaling), if set to true, a UE can limit CSI reports to an on-duration period of a DRX cycle.

For a csi-Mask, a csi-Mask can be applied/configured per:
a. DRX configuration
b. Group of DRX configurations
   i. E.g., ‘N’ first on-durations of the superimposed DRX configuration (comprising ‘M’ on-durations that are unio of all on-durations of active DX configurations, wherein ‘M’>‘N’)
c. All DRX configurations

For ps-TransmitOtherPeriodicCSI, a configuration can be implemented to report periodic CSI that is not L1-RSRP on PUCCH during a time duration indicated by drx-onDurationTimer in case DCP can be configured but associated drx-onDurationTimer may not be started.

In at least some implementations, ps-TransmitOtherPeriodicCSI can be configured per DRX configuration, per an aggregate DRX configuration, and/or can be configured and/or applied for a subset of DRX configurations. In at least one example, a UE applies the ps-TransmitOtherPeriodicCSI configuration for on-durations where WUS is monitored.

In at least some implementations, ps-TransmitPeriodicL1-RSRP indicates for a UE to transmit periodic L1-RSRP report(s) when the drx-onDurationTimer does not start. If the field is absent, the UE may not transmit periodic L1-RSRP report(s) when the drx-onDurationTimer does not start. In at least some implementations, this parameter can also be configured per DRX configuration, per the aggregate DRX configuration, and/or can be configured and/or applied for a subset of DRX configurations. In an example, the UE applies the ps-TransmitPeriodicL1-RSRP configuration for the on-durations where WUS is monitored.

In at least some implementations, for distribution of HARQ processes to DRX configurations, a number of HARQ process IDs can be configured for a DRX configuration or a group of DRX configurations. For instance, a UE can be configured with a number of HARQ processes (e.g., nrofHARQ-Processes) and a HARQ process offset (e.g., harq-ProcID-Offset) for each DRX configuration and/or group of DRX configurations and can determine the HARQ process IDs based on these parameters (e.g., nrofHARQ-Processes and harq-ProcID-Offset).

In at least some implementations, for configuration of DRX patterns, DRX parameters of a DRX configuration can be updated dynamically. Alternatively or additionally DRX cycles of a DRX configuration, periodically, can be semi-statically (e.g., via an RRC configured pattern) configured to have different DRX parameters than other DRX cycles of the DRX configuration.

In at least some implementations, a UE can be configured with a first DRX configuration and a second DRX configuration to run/be applicable simultaneously.
The first DRX configuration can have a first DRX cycle pattern, where:
   at least a first set of DRX cycles of the first DRX configuration has a first set of DRX parameter values (e.g., on-duration, or a pattern for start of the on-duration, or DRX cycle length); and
   a second set of DRX cycles of the second DRX configuration has a second set of DRX parameter values.
The second DRX configuration can have a second DRX cycle pattern, where:
   at least a third set of DRX cycles of the second DRX configuration has a third set of DRX parameter values (e.g., on-duration, or a pattern for start of the on-duration, or DRX cycle length); and
   a fourth set of DRX cycles of the second DRX configuration has a fourth set of DRX parameter values.
   Where a DCI indicates updated DRX parameters for a set of DRX cycles, the DCI can indicate the DRX configuration ID of the associated DRX configuration. Alternatively, the update could be applicable to
      all or a configured subset of DRX configurations or
      the DRX configuration(s) wherein the DCI is received within their active time or the DRX configurations wherein the DCI is received outside their active time or
      the DRX configuration wherein the DCI is received within its active time and its active time ends earlier than that of other simultaneous DRX configurations or
      the DRX configuration wherein the DCI is received outside its active time and its active time starts earlier than that of other simultaneous DRX configurations

In at least some implementations, a number of simultaneous DRX configurations and DRX configurations with periodic DRX cycle updates is reported as a UE capability. For instance, a UE in a UE capability report can indicate it can support ‘M’ simultaneous DRX configurations. This means, for example, the UE can also support ‘M−1’ simultaneous DRX configurations where one of the DRX configurations of the ‘M−1’ simultaneous DRX configurations has a first set of DRX cycles with a first set of DRX parameters and a second set of DRX cycles with a second set of DRX parameters. Such a DRX configuration can be counted as two virtual DRX configurations, leading to ‘M’ virtual simultaneous DRX configurations.

In at least some implementations, for periodic and/or semi-persistent UL transmissions, if a UE is not in active time during an OFDM symbol, it may not transmit periodic sounding reference signal (SRS) and semi-persistent SRS and not report CSI on PUCCH and semi-persistent CSI configured on PUSCH. The UE, for example, can be configured to skip such transmissions per DRX configuration and/or group of DRX configurations during:
a. active time;
b. on-duration/when IAT running;
c. outside active time;
   i. The configuration can be done for each signal separately
d. The UE can be configured to transmit such signals.

In at least some implementations, for drx-RetransmissionTimerUL DL there could be one retransmission timer per HARQ process for:
Each DRX configAll DRX configs
Group of DRX configs
   The group can contain one DRX configuration, and the one DRX configuration is determined based on the HARQ process ID and some of the DRX parameters: for instance, the DRX configuration is chosen among a set of DRX configurations associated with the HARQ process, wherein the DRX configuration has the latest ending active time or largest on-duration amongst the set of DRX configurations, or the DRX configuration ID is determined by RRC signaling

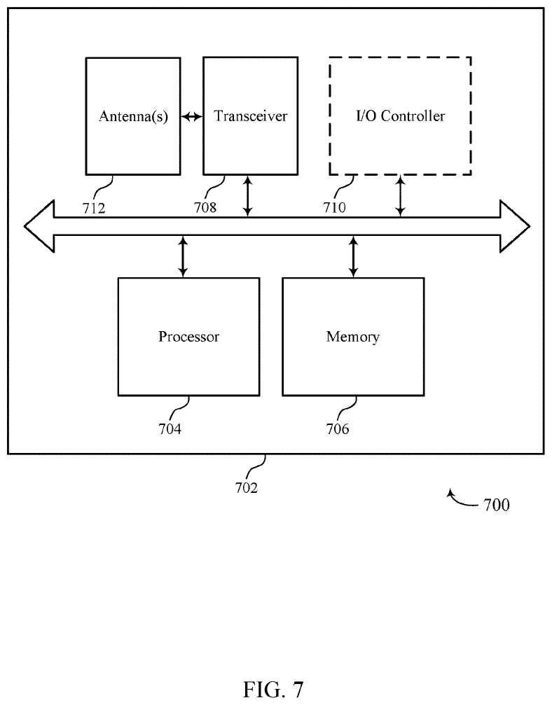

FIG. 7 illustrates an example of a block diagram 700 of a device 702 (e.g., an apparatus) that supports timing control in wireless communications in accordance with aspects of the present disclosure. The device 702 may be an example of UE 104 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706). In the context of UE 104, for example, the transceiver 708 and the processor coupled 704 coupled to the transceiver 708 are configured to cause the UE 104 to perform the various described operations and/or combinations thereof.

For example, the processor 704 and/or the transceiver 708 may support wireless communication at the device 702 in accordance with examples as disclosed herein. For instance, the processor 704 and/or the transceiver 708 may be configured as and/or otherwise support a means to receive a first DRX configuration including a set of DRX configuration parameters; receive a DCI including a change indication indicating at least one of an increase or a decrease to one or more of a first configuration value of a first DRX configuration parameter of the set of DRX configuration parameters, or a first timer value of a first DRX timer of a set of DRX cycles; configure one or more of a second timer value for a second DRX timer or a second configuration value for a second DRX configuration parameter based at least in part on the change indication and at least one of the first DRX configuration parameter or the first timer value; and monitor PDCCH for a MAC entity according to a DRX functionality with at least one of: the second DRX timer configured with the second timer value; or the second configuration value for the second DRX configuration parameter.

Further, in some implementations, the DCI is received with a DCI format, and the processor and the transceiver are configured to: receive the DCI not later than a first threshold with respect to a first time reference; or receive the DCI as an nth DCI with the DCI format received in a time window, where n<n0 and n0 includes a second threshold; where the processor and the transceiver are configured to determine the first time reference based on a boundary of a current DRX cycle of the first DRX configuration; where the set of DRX configuration parameters include one or more of: a connected mode DRX (C-DRX) cycle length; an initial value for a DRX on duration timer; an initial value for a DRX inactivity timer; or a start time instance of a DRX on duration timer; where the processor and the transceiver are configured to receive the DCI within an active time of a current DRX cycle of the first DRX configuration; where the processor and the transceiver are configured to transmit a hybrid automatic repeat request acknowledgement (HARQ-ACK) in response to the DCI before an end of a current DRX cycle.

Further, in some implementations, the first DRX configuration parameter includes a starting time instance of a DRX on duration timer associated with a next DRX cycle of the first DRX configuration, and the second DRX timer is a DRX ShortCycleTimer, where the DRX ShortCycleTimer indicates when to transition to a long DRX cycle from a short DRX cycle; where the first DRX configuration parameter includes a drx-ShortCycle and the second DRX configuration parameter includes a drx-LongCycle, and where the drx-LongCycle is not a multiple of the drx-ShortCycle; where the processor and the transceiver are configured to receive the DCI outside an active time of a current DRX cycle of the first DRX configuration; where the processor and the transceiver are configured to receive the DCI within a minimum time gap from a time reference, and where the time reference is determined based on the DCI and a starting time instance of a DRX on duration timer associated with a next DRX cycle of the first DRX configuration; where the set of DRX cycles includes at least one of a current DRX cycle or a next DRX cycle of the first DRX configuration.

Further, in some implementations, the apparatus is configured with at least two DRX groups; a first set of serving cells belongs to a primary DRX group; a second set of serving cells belongs to a secondary DRX group; the first DRX configuration belongs to the secondary DRX group, and the DCI causes a value of one or more of a DRX on duration timer or a DRX inactivity timer of the secondary DRX group to become larger than a corresponding value in the primary DRX group for a subset of DRX cycles; where: the apparatus is configured with at least two DRX groups; a first set of serving cells belongs to a primary DRX group; a second set of serving cells belongs to a secondary DRX group; and the DCI indicates the increase or decrease belongs is associated with which DRX group; where the DCI schedules a one or more of a PDSCH or a PUSCH; where the processor and the transceiver are configured to receive the DCI at least t time units later than a different DCI of a same DCI format indicating a change to one or more DRX parameters; where the DCI includes one or more of: a DRX configuration identifier (ID) or a DRX set ID associated with the change indication; an indication of a DRX cycle ID to which the change indication applies; an indication of a DRX index to which the change indication applies; or a DRX group identifier; where the change indication applies; where the apparatus includes a user equipment (UE) and where the processor and the transceiver are configured to receive one or more of the first DRX configuration or the DCI from a network device.

In a further example, the processor 704 and/or the transceiver 708 may support wireless communication at the device 702 in accordance with examples as disclosed herein. The processor 704 and/or the transceiver 708, for instance, may be configured as or otherwise support a means to receive a first DCI indicating an activity status for a first set of DRX configurations; configure a DRX behavior based at least in part on a time instance associated with the activity status, wherein the time instance is determined based on at least one of a number of DRX configurations of the first set of DRX configurations, or a first DRX cycle length of one or more DRX configurations; and configure a PDCCH behavior based at least in part on the DRX behavior and the determined time instance.

Further, in at least some implementations, the activity status includes an activation of the first set of DRX configurations, and the PDCCH behavior includes an indication to monitor PDCCH based at least in part on the first set of DRX configurations; where the processor and the transceiver are configured to cause the apparatus to monitor PDCCH based at least in part on a combination of on-durations of the first set of DRX configurations from the time instance; where the activity status includes a deactivation of the first set of DRX configurations, and the PDCCH behavior includes an indication to not monitor PDCCH based at least in part on the first set of DRX configurations; where the processor and the transceiver are configured to cause the apparatus to determine the first set of DRX configurations based on higher layer signaling, and where the higher layer signaling includes one or more of RRC configuration or MAC CE signaling.

Further, in at least some implementations, the processor and the transceiver are configured to cause the apparatus to: receive a DRX command MAC CE; terminate one or more current active times of a second set of DRX configurations; and enter a regular DRX cycle routine of the second set of DRX configurations; where the DRX command MAC-CE includes configuration identifiers (IDs) of DRX configurations of the second set of DRX configurations; where the first DRX cycle length includes a multiple of a second DRX cycle length of the first set of DRX configurations; where: serving cells of a MAC entity are configurable by RRC into at least two DRX groups; the first set of DRX configurations is applicable a first DRX group; and a subset of the first set of DRX configurations is applicable to a second DRX group; where the processor and the transceiver are configured to cause the apparatus to transmit one or more CSI reports only in an on-duration period of a subset of first set of DRX configurations.

Further, in at least some implementations, the processor and the transceiver are configured to cause the apparatus to: receive a second DCI outside of a DRX active time, where: the second DCI includes a WUS indication indicating whether the apparatus is to skip an on-duration of an upcoming DRX cycle of a first DRX configuration of the first set of DRX configurations; and the DCI indicates an identifier (ID) of the first DRX configuration; where the processor and the transceiver are configured to cause the apparatus to not monitor PDCCH within a configured time gap from any DRX on-duration of the first set of DRX configurations; where the processor and the transceiver are configured to cause the apparatus to receive one or more of: a first ps-TransmitOtherPeriodicCSI configuration which is applicable to a first DRX configuration; or a second ps-TransmitOtherPeriodicCSI configuration which is applicable to a second DRX configuration; where the processor and the transceiver are configured to cause the apparatus to: receive a ps-TransmitOtherPeriodicCSI configuration, where: the first DCI indicates applicability of ps-TransmitOtherPeriodicCSI configuration to one or more DRX configurations of the first set of DRX configurations; and the ps-TransmitOtherPeriodicCSI configuration is configured to cause the apparatus to transmit one or more periodic CSI reports when a drx-onDuration Timer of the one or more DRX configurations of the first set of DRX configurations does not start.

Further, in at least some implementations, the one or more periodic CSI reports include one or more CSI reports other than a layer 1 reference signal received power (L1-RSRP) report; where the processor and the transceiver are configured to cause the apparatus to monitor for the WUS within a time window of one or more of: Ps_offset1 slots prior to a beginning of an on-duration of a DRX cycle of a first DRX configuration; or Ps_offset2 slots prior to a beginning of an on-duration of a DRX cycle of a second DRX configuration; where the Ps_offset2 is determined based on one or more of: Ps_offset1; a first DRX configuration; or a second DRX configuration; where: a first set of hybrid automatic repeat request (HARQ) process identifiers (IDs) are configured for a first DRX configuration; and a second set of HARQ process IDs are configured for a second DRX configuration, where at least one HARQ process ID is different for the first DRX configuration and the second DRX configuration, and where the first DRX configuration and the second DRX configuration are from the first set of DRX configurations.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor M08. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (e.g., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

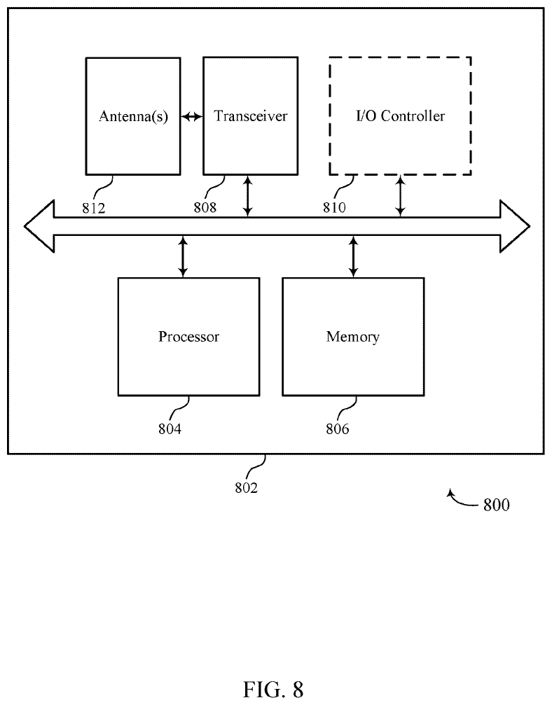

FIG. 8 illustrates an example of a block diagram 800 of a device 802 (e.g., an apparatus) that supports timing control in wireless communications in accordance with aspects of the present disclosure. The device 802 may be an example of a network entity 102 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806). In the context of network entity 102, for example, the transceiver 808 and the processor 804 coupled to the transceiver 808 are configured to cause the network entity 102 to perform the various described operations and/or combinations thereof.

For example, the processor 804 and/or the transceiver 808 may support wireless communication at the device 802 in accordance with examples as disclosed herein. For instance, the processor 804 and/or the transceiver 808 may be configured as or otherwise support a means to transmit a first DRX configuration including a set of DRX configuration parameters; transmit a DCI including a change indication indicating at least one of an increase or a decrease to one or more of a first configuration value of a first DRX configuration parameter of the set of DRX configuration parameters, or a first timer value of a first DRX timer of a set of DRX cycles; configure one or more of a second timer value for a second DRX timer or a second configuration value for a second DRX configuration parameter based at least in part on the change indication and at least one of the first DRX configuration parameter or the first timer value; determine a DRX active time based on one or more of the second DRX timer or the second DRX configuration parameter; and transmit data in the DRX active time.

Further, in some implementations, the DCI is transmitted with a DCI format, and where the processor and the transceiver are configured to transmit the DCI not later than a first threshold with respect to a first time reference; or transmit the DCI as an nth DCI with the DCI format transmitted in a time window, where n<n0 and no includes a second threshold; where the set of DRX configuration parameters include one or more of: a connected mode DRX (C-DRX) cycle length; an initial value for a DRX on duration timer; an initial value for a DRX inactivity timer; or a start time instance of a DRX on duration timer; where the processor and the transceiver are configured to transmit the DCI within an active time of a current DRX cycle of the first DRX configuration; where the processor and the transceiver are configured to receive a hybrid automatic repeat request acknowledgement (HARQ-ACK) before an end of a current DRX cycle; where the first DRX configuration parameter includes a starting time instance of a DRX on duration timer associated with a next DRX cycle of the first DRX configuration, and the second DRX timer is a DRX ShortCycleTimer, where the DRX ShortCycleTimer indicates when to transition to a long DRX cycle from a short DRX cycle.

Further, in some implementations, the first DRX configuration parameter includes a drx-ShortCycle and the second DRX configuration parameter includes a drx-LongCycle, and where the drx-LongCycle is not a multiple of the drx-ShortCycle; where the processor and the transceiver are configured to transmit the DCI outside an active time of a current DRX cycle of the first DRX configuration; where the processor and the transceiver are configured to transmit the DCI within a minimum time gap from a time reference, and where the time reference is determined based on the DCI and a starting time instance of a DRX on duration timer associated with a next DRX cycle of the first DRX configuration; where the set of DRX cycles includes at least one of a current DRX cycle or a next DRX cycle of the first DRX configuration; where: a first set of serving cells belongs to a primary DRX group; a second set of serving cells belongs to a secondary DRX group; the first DRX configuration belongs to the secondary DRX group, and the DCI causes a value of one or more of a DRX on duration timer or a DRX inactivity timer of the secondary DRX group become larger than a corresponding value in the primary DRX group for a subset of DRX cycles.

Further, in some implementations, an apparatus is configured with at least two DRX groups; a first set of serving cells belongs to a primary DRX group; a second set of serving cells belongs to a secondary DRX group; and the DCI indicates the increase or decrease belongs is associated with which DRX group; where the DCI schedules a one or more of a PDSCH or a PUSCH; where the processor and the transceiver are configured to transmit the DCI at least t time units later than a different DCI of a same DCI format indicating a change to one or more DRX parameters; where the DCI includes one or more of: a DRX configuration identifier (ID) or a DRX set ID associated with the change indication; an indication of a DRX cycle ID to which the change indication applies; an indication of a DRX index to which the change indication applies; or a DRX group identifier; where the change indication applies.

In a further example, the processor 804 and/or the transceiver 808 may support wireless communication at the device 802 in accordance with examples as disclosed herein. The processor 804 and/or the transceiver 808, for instance, may be configured as or otherwise support a means to transmit DCI indicating to activate a first set of DRX configurations; determine a time instance after which the first set of DRX configurations is applicable, wherein the time instance is determined based on at least one of a number of DRX configurations of the first set of DRX configurations, or a DRX cycle length of one or more DRX configurations; and transmit a PDCCH in a DRX active time determined based at least in part on on-durations of the first set of DRX configurations from the time instance.

Further, in some implementations, the processor and the transceiver are configured to transmit a DRX command MAC CE, where the DRX command MAC-CE includes configuration identifiers (IDs) of DRX configurations of a second set of DRX configurations; where the processor and the transceiver are configured to cause the apparatus to: transmit, to a user equipment (UE), a second DCI outside of a DRX active time, where: the second DCI includes a WUS indication indicating whether the UE is to skip an on-duration of an upcoming DRX cycle of a first DRX configuration of the first set of DRX configurations; and the DCI indicates an identifier (ID) of the first DRX configuration; where the processor and the transceiver are configured to transmit one or more of: a first ps-TransmitOtherPeriodicCSI configuration which is applicable to a first DRX configuration; or a second ps-TransmitOtherPeriodicCSI configuration which is applicable to a second DRX configuration; where the processor and the transceiver are configured to transmit a ps-TransmitOtherPeriodicCSI configuration, where: the first DCI indicates applicability of ps-TransmitOtherPeriodicCSI configuration to one or more DRX configurations of the first set of DRX configurations; and the ps-TransmitOtherPeriodicCSI configuration is configured to cause the apparatus to transmit one or more periodic CSI reports when a drx-onDurationTimer of the one or more DRX configurations of the first set of DRX configurations does not start.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor M06. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (e.g., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

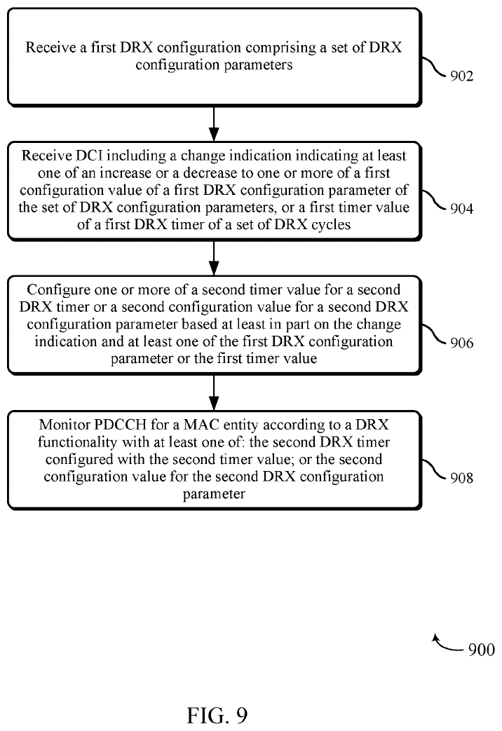

FIG. 9 illustrates a flowchart of a method 900 that supports timing control in wireless communications in accordance with aspects of the present disclosure. The operations of the method 900 may be implemented by a device or its components as described herein. For example, the operations of the method 900 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 902, the method may include receiving a first DRX configuration including a set of DRX configuration parameters. The operations of 902 may be performed in accordance with examples as described herein. In some implementations, aspects of the operations of 902 may be performed by a device as described with reference to FIG. 1.

At 904, the method may include receiving DCI including a change indication indicating at least one of an increase or a decrease to one or more of a first configuration value of a first DRX configuration parameter of the set of DRX configuration parameters, or a first timer value of a first DRX timer of a set of DRX cycles. The operations of 904 may be performed in accordance with examples as described herein. In some implementations, aspects of the operations of 904 may be performed by a device as described with reference to FIG. 1.

At 906, the method may include configuring one or more of a second timer value for a second DRX timer or a second configuration value for a second DRX configuration parameter based at least in part on the change indication and at least one of the first DRX configuration parameter or the first timer value. The operations of 906 may be performed in accordance with examples as described herein. In some implementations, aspects of the operations of 906 may be performed by a device as described with reference to FIG. 1.

At 908, the method may include monitoring PDCCH for a MAC entity according to a DRX functionality with at least one of: the second DRX timer configured with the second timer value; or the second configuration value for the second DRX configuration parameter. The operations of 908 may be performed in accordance with examples as described herein. In some implementations, aspects of the operations of 908 may be performed by a device as described with reference to FIG. 1.

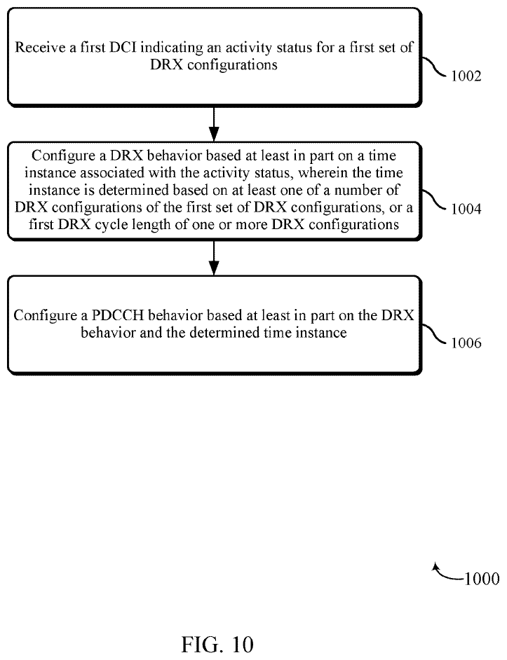

FIG. 10 illustrates a flowchart of a method 1000 that supports timing control in wireless communications in accordance with aspects of the present disclosure. The operations of the method 1000 may be implemented by a device or its components as described herein. For example, the operations of the method 1000 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1002, the method may include receiving a first DCI indicating an activity status for a first set of DRX configurations. The operations of 1002 may be performed in accordance with examples as described herein. In some implementations, aspects of the operations of 1002 may be performed by a device as described with reference to FIG. 1.

At 1004, the method may include configuring a DRX behavior based at least in part on a time instance associated with the activity status, wherein the time instance is determined based on at least one of a number of DRX configurations of the first set of DRX configurations, or a first DRX cycle length of one or more DRX configurations. The operations of 1004 may be performed in accordance with examples as described herein. In some implementations, aspects of the operations of 1004 may be performed by a device as described with reference to FIG. 1.

At 1006, the method may include configuring a PDCCH behavior based at least in part on the DRX behavior and the determined time instance. The operations of 1006 may be performed in accordance with examples as described herein. In some implementations, aspects of the operations of 1006 may be performed by a device as described with reference to FIG. 1.

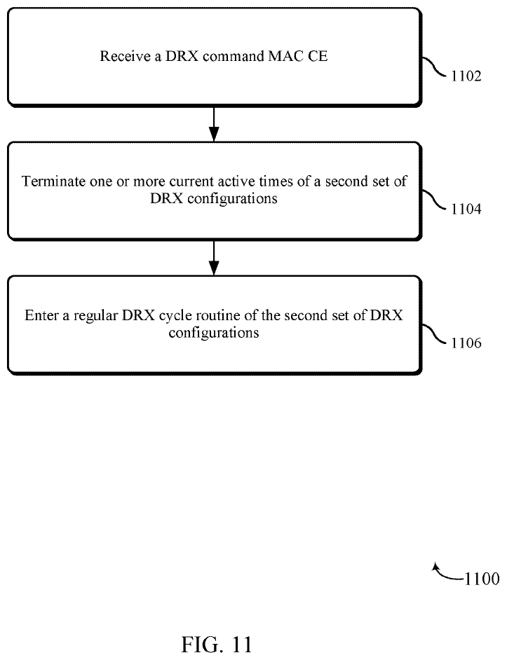

FIG. 11 illustrates a flowchart of a method 1100 that supports timing control in wireless communications in accordance with aspects of the present disclosure. The operations of the method 1100 may be implemented by a device or its components as described herein. For example, the operations of the method 1100 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1102, the method may include receiving a DRX command MAC CE. The operations of 1102 may be performed in accordance with examples as described herein. In some implementations, aspects of the operations of 1102 may be performed by a device as described with reference to FIG. 1.

At 1104, the method may include terminating one or more current active times of a second set of DRX configurations. The operations of 1104 may be performed in accordance with examples as described herein. In some implementations, aspects of the operations of 1104 may be performed by a device as described with reference to FIG. 1.

At 1106, the method may include entering a regular DRX cycle routine of the second set of DRX configurations. The operations of 1106 may be performed in accordance with examples as described herein. In some implementations, aspects of the operations of 1106 may be performed by a device as described with reference to FIG. 1.

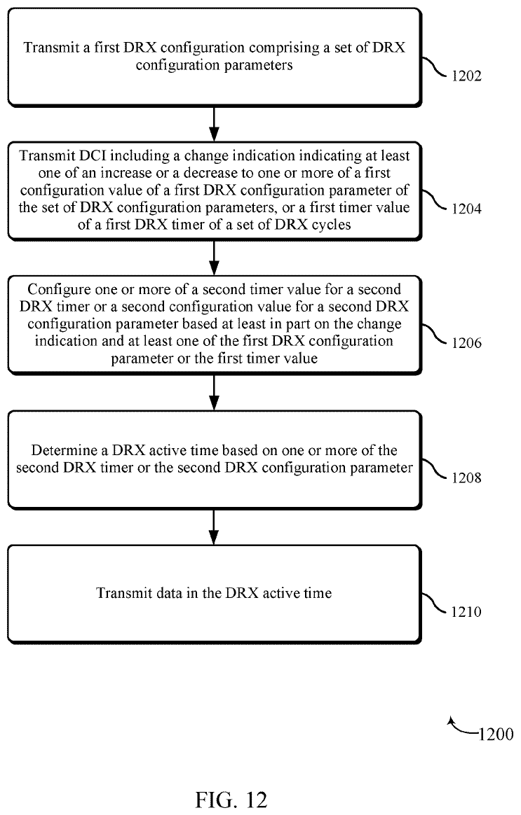

FIG. 12 illustrates a flowchart of a method 1200 that supports timing control in wireless communications in accordance with aspects of the present disclosure. The operations of the method 1200 may be implemented by a device or its components as described herein. For example, the operations of the method 1200 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1202, the method may include transmitting a first DRX configuration comprising a set of DRX configuration parameters. The operations of 1202 may be performed in accordance with examples as described herein. In some implementations, aspects of the operations of 1202 may be performed by a device as described with reference to FIG. 1.

At 1204, the method may include transmitting DCI including a change indication indicating at least one of an increase or a decrease to one or more of a first configuration value of a first DRX configuration parameter of the set of DRX configuration parameters, or a first timer value of a first DRX timer of a set of DRX cycles. The operations of 1204 may be performed in accordance with examples as described herein. In some implementations, aspects of the operations of 1204 may be performed by a device as described with reference to FIG. 1.

At 1206, the method may include configuring one or more of a second timer value for a second DRX timer or a second configuration value for a second DRX configuration parameter based at least in part on the change indication and at least one of the first DRX configuration parameter or the first timer value. The operations of 1206 may be performed in accordance with examples as described herein. In some implementations, aspects of the operations of 1206 may be performed by a device as described with reference to FIG. 1.

At 1208, the method may include determining a DRX active time based on one or more of the second DRX timer or the second DRX configuration parameter. The operations of 1208 may be performed in accordance with examples as described herein. In some implementations, aspects of the operations of 1208 may be performed by a device as described with reference to FIG. 1.

At 1210, the method may include transmitting data in the DRX active time. The operations of 1210 may be performed in accordance with examples as described herein. In some implementations, aspects of the operations of 1210 may be performed by a device as described with reference to FIG. 1.

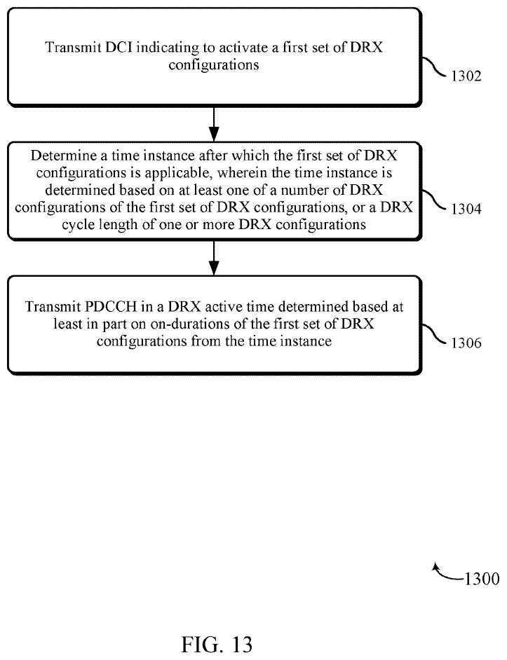

FIG. 13 illustrates a flowchart of a method 1300 that supports timing control in wireless communications in accordance with aspects of the present disclosure. The operations of the method 1300 may be implemented by a device or its components as described herein. For example, the operations of the method 1300 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1302, the method may include transmitting DCI indicating to activate a first set of DRX configurations. The operations of 1302 may be performed in accordance with examples as described herein. In some implementations, aspects of the operations of 1302 may be performed by a device as described with reference to FIG. 1.

At 1304, the method may include determining a time instance after which the first set of DRX configurations is applicable, wherein the time instance is determined based on at least one of a number of DRX configurations of the first set of DRX configurations, or a DRX cycle length of one or more DRX configurations. The operations of 1304 may be performed in accordance with examples as described herein. In some implementations, aspects of the operations of 1304 may be performed by a device as described with reference to FIG. 1.

At 1306, the method may include transmitting PDCCH in a DRX active time determined based at least in part on on-durations of the first set of DRX configurations from the time instance. The operations of 1306 may be performed in accordance with examples as described herein. In some implementations, aspects of the operations of 1306 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, the UE comprising:
at least one memory; and
at least one processor coupled with the at least one memory and configured to cause the UE to:
receive a first discontinuous reception (DRX) configuration comprising a set of DRX configuration parameters;
receive a downlink control information (DCI) comprising a change indication indicating at least one of an increase or a decrease to one or more of a first configuration value of a first DRX configuration parameter of the set of DRX configuration parameters, or a first timer value of a first DRX timer of a set of DRX cycles;
configure one or more of a second timer value for a second DRX timer or a second configuration value for a second DRX configuration parameter based at least in part on the change indication and at least one of the first DRX configuration parameter or the first timer value; and
monitor physical downlink control channel (PDCCH) for a media access control (MAC) entity according to a DRX functionality with at least one of:
the second DRX timer configured with the second timer value; or
the second configuration value for the second DRX configuration parameter.

2. The UE of claim 1, wherein the DCI is received with a DCI format, and wherein the at least one processor is configured to cause the UE to:
receive the DCI not later than a first threshold with respect to a first time reference; or
receive the DCI as an n^{th} DCI with the DCI format received in a time window, wherein n<n₀ and n₀ comprises a second threshold.

3. The UE of claim 2, wherein the at least one processor is configured to cause the UE to determine the first time reference based on a boundary of a current DRX cycle of the first DRX configuration.

4. The UE of claim 1, wherein the set of DRX configuration parameters comprise one or more of:
a connected mode DRX (C-DRX) cycle length;
an initial value for a DRX on duration timer;
an initial value for a DRX inactivity timer; or
a start time instance of a DRX on duration timer.

5. The UE of claim 1, wherein the at least one processor is configured to cause the UE to receive the DCI within an active time of a current DRX cycle of the first DRX configuration.

6. The UE of claim 1, wherein at least one processor is configured to cause the UE to transmit a hybrid automatic repeat request acknowledgement (HARQ-ACK) in response to the DCI before an end of a current DRX cycle.

7. The UE of claim 1, wherein the first DRX configuration parameter comprises a starting time instance of a DRX on duration timer associated with a next DRX cycle of the first DRX configuration, and the second DRX timer is a DRX ShortCycleTimer, wherein the DRX ShortCycleTimer indicates when to transition to a long DRX cycle from a short DRX cycle.

8. The UE of claim 1, wherein the first DRX configuration parameter comprises a drx-ShortCycle and the second DRX configuration parameter comprises a drx-LongCycle, and wherein the drx-LongCycle is not a multiple of the drx-ShortCycle.

9. The UE of claim 1, wherein the at least one processor is configured to cause the UE to receive the DCI outside an active time of a current DRX cycle of the first DRX configuration.

10. A network entity for wireless communication, comprising:
at least one memory; and
at least one processor coupled with the at least one memory and configured to cause the network entity to:
transmit a first discontinuous reception (DRX) configuration comprising a set of DRX configuration parameters;
transmit a downlink control information (DCI) comprising a change indication indicating at least one of an increase or a decrease to one or more of a first configuration value of a first DRX configuration parameter of the set of DRX configuration parameters, or a first timer value of a first DRX timer of a set of DRX cycles;
configure one or more of a second timer value for a second DRX timer or a second configuration value for a second DRX configuration parameter based at least in part on the change indication and at least one of the first DRX configuration parameter or the first timer value;
determine a DRX active time based on one or more of the second DRX timer or the second DRX configuration parameter; and
transmit data in the DRX active time.

11. The network entity of claim 10, wherein the DCI is transmitted with a DCI format, and wherein the at least one processor is configured to cause the network entity to:
transmit the DCI not later than a first threshold with respect to a first time reference; or
transmit the DCI as an n^{th} DCI with the DCI format transmitted in a time window, wherein n<n₀ and n₀ comprises a second threshold.

12. The network entity of claim 10, wherein the set of DRX configuration parameters comprise one or more of:
a connected mode DRX (C-DRX) cycle length;
an initial value for a DRX on duration timer;
an initial value for a DRX inactivity timer; or
a start time instance of a DRX on duration timer.

13. The network entity of claim 10, wherein the at least one processor is configured to cause the network entity to transmit the DCI within an active time of a current DRX cycle of the first DRX configuration.

14. The network entity of claim 10, wherein the at least one processor is configured to cause the network entity to receive a hybrid automatic repeat request acknowledgement (HARQ-ACK) before an end of a current DRX cycle.

15. The network entity of claim 10, wherein the first DRX configuration parameter comprises a starting time instance of a DRX on duration timer associated with a next DRX cycle of the first DRX configuration, and the second DRX timer is a DRX ShortCycleTimer, wherein the DRX ShortCycleTimer indicates when to transition to a long DRX cycle from a short DRX cycle.

16. The network entity of claim 10, wherein the first DRX configuration parameter comprises a drx-ShortCycle and the second DRX configuration parameter comprises a drx-LongCycle, and wherein the drx-LongCycle is not a multiple of the drx-ShortCycle.

17. The network entity of claim 10, wherein the at least one processor is configured to cause the network entity to transmit the DCI outside an active time of a current DRX cycle of the first DRX configuration.

18. The network entity of claim 10, wherein the at least one processor is configured to cause the network entity to transmit the DCI within a minimum time gap from a time reference, and wherein the time reference is determined based on the DCI and a starting time instance of a DRX on duration timer associated with a next DRX cycle of the first DRX configuration.

19. A method performed by a user equipment (UE), the method comprising:
receiving a first discontinuous reception (DRX) configuration comprising a set of DRX configuration parameters;
receiving a downlink control information (DCI) comprising a change indication indicating at least one of an increase or a decrease to one or more of a first configuration value of a first DRX configuration parameter of the set of DRX configuration parameters, or a first timer value of a first DRX timer of a set of DRX cycles;
configuring one or more of a second timer value for a second DRX timer or a second configuration value for a second DRX configuration parameter based at least in part on the change indication and at least one of the first DRX configuration parameter or the first timer value; and
monitoring physical downlink control channel (PDCCH) for a media access control (MAC) entity according to a DRX functionality with at least one of:
the second DRX timer configured with the second timer value; or
the second configuration value for the second DRX configuration parameter.

20. A processor for wireless communication, comprising:
at least one controller coupled with at least one memory and configured to cause the processor to:
receive a first discontinuous reception (DRX) configuration comprising a set of DRX configuration parameters;
receive a downlink control information (DCI) comprising a change indication indicating at least one of an increase or a decrease to one or more of a first configuration value of a first DRX configuration parameter of the set of DRX configuration parameters, or a first timer value of a first DRX timer of a set of DRX cycles;
configure one or more of a second timer value for a second DRX timer or a second configuration value for a second DRX configuration parameter based at least in part on the change indication and at least one of the first DRX configuration parameter or the first timer value; and
monitor physical downlink control channel (PDCCH) for a media access control (MAC) entity according to a DRX functionality with at least one of:
the second DRX timer configured with the second timer value; or
the second configuration value for the second DRX configuration parameter.
